(19) United States
(12) Patent Application Publication
(10) Pub. No.: US 2008/0217460 A1
(43) Pub. Date: Sep. 11, 2008

(54) Lifting Apparatus Having Lifting Reel

(76) Inventor: Jeong-Hun Shin, Jeollanam-do (KR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/997,288

(22) PCT Filed: Apr. 17, 2007
(86) PCT No.: PCT/KR2007/001870

§ 371 Date: Jan. 29, 2008

(30) Foreign Application Priority Data
Apr. 17, 2006 (KR) 1020060034385
Apr. 17, 2006 (KR) 1020060034386
Jun. 17, 2006 (KR) 1020060054592
Jun. 17, 2006 (KR) 1020060054593
Jun. 17, 2006 (KR) 1020060054594
Jun. 17, 2006 (KR) 1020060054595
Jun. 29, 2006 (KR) 1020060059059
Mar. 2, 2007 (KR) 1020070020740
Mar. 22, 2007 (KR) 1020070027942

(51) Int. Cl. B65H 75/44; B66D 1/30

(52) U.S. Cl. 242/390.1; 242/390; 242/390.8

(57) ABSTRACT

A lifting apparatus includes a fixed unit positioned at a predetermined height, a moving unit installed below the fixed unit to be movable up/down, and at least one lifting reel to move the moving unit up/down. The lifting reel includes a body installed to the fixed unit; a drum arranged in the body and rotated in a clockwise/counterclockwise direction; a wire fixed to the drum and connected to the moving unit to be wound/unwound around the drum; a fixed roll spaced apart from the drum and rotated on a fixed roll shaft to guide the wire while the wire taken-up around the drum is wound or unwound; and at least two guide rolls arranged between the drum and the fixed roll to guide the wire, wherein the at least two guide rolls guide the wire substantially perpendicular to the drum while the wire is wound around the drum.

### TECHNICAL FIELD

The present invention relates to a lifting apparatus having a lifting reel, and more particularly to a lifting apparatus having a lifting reel that safely lifts a moving unit (for example, a highly-mounted lamp, a grill for an air conditioner, a chandelier, a batten for lights above the stage, and so on) connected to a lower end of a wire such that the moving unit is not inclined.

### BACKGROUND ART

Generally, various products moving up and down using a wire have been put into the market. Such products having a lifting function are as follows.

First, a highly-mounted lamp is installed on the ceiling of a building such as a factory or a gymnasium to illuminate the interior of a room. Also, a grill of an air conditioner is positioned to a lower end of a main body fixed to the ceiling and inhales an air in a room so as to discharge a cool or hot air generated in the air conditioner into the room. In addition, a chandelier is installed to the ceiling of a building such as a hotel lobby or a wedding hall to give a deluxe lighting. Also, a batten for lights above the stage is installed to various stages for public performances and used for assembling lights or drop curtain. There are also various kinds of products that are partially or entirely lifted.

The highly-mounted lamp, the grill for an air conditioner, the chandelier and the batten for the stage (hereinafter, referred to as a product), mentioned above, are used in different usages, but they are all installed to the ceiling of a building. Thus, after a long time use, the product is worn due to its life cycle or soiled due to accumulated dirt, so the product needs periodical cleaning or exchange. At this time, in order to facilitate the exchange or cleaning work in a more convenient and easier way, a lifting reel for moving the product down to the ground is installed to the product.

Seeing a conventional lifting reel in brief, the conventional lifting reel includes a body fixed to the ceiling, a drum arranged in the body and rotated by a driving motor in a clockwise/counterclockwise direction, a wire fixed to the drum at its one end and connected to a product to be lifted at the other end and wound on or unwound from the drum, and a fixed roll keeping a constant space from the drum and rotating on a fixed roll shaft so as to guide the wire while the wire taken up around the drum is wound/unwound. At an end of the wire, various products such as a highly-mounted lamp, a grill for an air conditioner, a chandelier, and a batten for lighting above the stage may be installed depending on its purpose.

When cleaning or exchanging such a product, the lifting reel descends the product from the ceiling to the ground, and the lifting reel ascends the product again to the ceiling after the cleaning or exchanging work. At this time, one guide roll is installed in the conventional lifting reel between the drum and the fixed roll. This guide roll plays a role of guiding the wire when taking up a descended wire. However, since the conventional lifting reel guides the wire only with one guide roll, the wire is not uniformly wound on the entire area of the drum. That is, the conventional guide roll can just move a little in a lateral direction based on the center of the drum due to its structure, so the wire is mostly wound in a center region of the drum. Thus, while the wire is wound around the drum, a taking-up speed of the wire is changed, thereby causing the lifting product to be inclined.

In order to prevent the wire from being wound mostly on a central region of the drum, it is possible to decrease a width of the drum and increase its outer circumference, or arrange the guide roll at a long distance from the drum. However, in this case, the lifting reel has a greater size, thereby deteriorating the competitive power of the product. In addition, this lifting reel cannot take up a large amount of wire, so it cannot be used for the ceiling with a great height.

In addition, a conventional lifting apparatus such as an air conditioner at the ceiling generally employs a plurality of lifting reels so as to lift a moving unit such as a grill. However, if the lifting reels have different taking-up speeds, the moving unit cannot keep its balance but be inclined, thereby resulting in incomplete coupling between the moving unit and a fixed unit of the lifting apparatus.

Also, a conventional lifting apparatus fixes a wire of a lifting reel in a given way using single or two lines, but it cannot fix the wire using both ways, thereby causing limitations in its usage.

In addition, a conventional lifting apparatus cannot easily balance the moving unit when hanging the moving unit to a wire, and the moving unit may be inclined to one side while moving up or down after being connected to the wire.

Also, a conventional lifting apparatus has a hook installed to a lower end of the wire of the lifting reel, and a separate hook fixture is used for connecting the hook to the wire. However, since the hook and the hook fixture are provided separately in the conventional one, the number of necessary parts is great and the process of installing the hook to the wire is complicated.

### DISCLOSURE OF INVENTION

### Technical Problem

The present invention is designed in consideration of the above problems, and therefore it is an object of the invention to provide a lifting apparatus for safely lifting a product (e.g., a highly-mounted lamp, a grill for an air conditioner, a chandelier, and a batten for lights above the stage) connected to a lower end of a wire such that the product is not inclined, by means of a plurality of guide rolls that allow the wire to be uniformly wound around the entire outer circumference of a drum.

Another object of the present invention is to provide a lifting apparatus capable of safely and easily lifting a moving unit such that the moving unit is not inclined, by means of electrically connecting a plurality of lifting reels and controlling them at the same time.

Still another object of the present invention is to provide a lifting apparatus capable of accurately moving a moving unit connected to a wire to a desired position without being inclined, by means of detecting a rotation of a drum and controlling a taking-up amount of the wire.

Further another object of the present invention is to provide a lifting apparatus having a lifting reel that may selectively fix a wire in a one-line or two-line fixing structure, by means of selectively fixing an end of the wire to the lifting reel.

Still another object of the present invention is to provide a lifting apparatus in which a horizontal wire with a tension is installed on a moving unit, and a wire of the lifting reel is connected to the horizontal wire such that the moving unit may be lifted with keeping its balance without any inclination.

Further another object of the present invention is to provide a lifting apparatus capable of easily balancing a moving unit connected to a wire by forming a guide wall to an upper point of the moving unit, and also continuously keeping the balance by maintaining a connection point of the wire though an external impact is applied to the moving unit while the moving unit is lifted.

Still another object of the present invention is to provide a lifting apparatus provided with a hook and a fixture in an integrated manner without using a separate fixture for coupling a hook connected to a lower end of the wire to the hook, thereby reducing the number of parts and facilitating easier connection between the hook and the wire.

Further another object of the present invention is to provide a lifting apparatus capable of keeping a balance of a moving unit easily by attaching a magnet to the moving unit.

### Technical Solution

In order to accomplish the above object, the present invention provides a lifting apparatus including a fixed unit positioned at a predetermined height and a moving unit installed below the fixed unit to be movable up and down, the lifting apparatus including at least one lifting reel to move the moving unit up and down, the lifting reel including: a body installed to the fixed unit; a drum arranged in the body and rotated by a driving motor in a clockwise/counterclockwise direction; a wire connected to the moving unit with one end being fixed to the drum so as to be wound or unwound around the drum; a fixed roll spaced apart from the drum by a predetermined distance and rotated on a fixed roll shaft to guide the wire while the wire taken-up around the drum is wound or unwound; and at least two guide rolls arranged between the drum and the fixed roll to guide the wire, wherein the at least two guide rolls guide the wire substantially perpendicular to the drum while the wire is wound around the drum.

Preferably, two or three guide rolls are arranged between the drum and the fixed roll, and the guide rolls are rotatably coupled to guide roll shafts respectively and movable in an axial direction on the guide roll shafts.

The guide rolls may be composed of a first guide roll and a second guide roll, and the first and second guide rolls are vertically arranged by a predetermined interval.

As an alternative, the guide rolls are composed of a first guide roll and a second guide roll, and the first and second guide rolls are arranged in a zigzag pattern.

As another alternative, the guide rolls are composed of a first guide roll, a second guide roll and a third guide roll, and the first, second and third guide rolls are vertically arranged.

As still another alternative, the guide rolls are composed of a first guide roll, a second guide roll and a third guide roll, and the first, second and third guide rolls are arranged in a zigzag pattern.

In another aspect of the present invention, the lifting reel further includes: a detection region formed on the drum; a limit switch for detecting the detection region to count a rotation of the drum; and a controller for receiving the rotation count detected by the limit switch, and rotating the drum as much as a preset number of rotations such that the moving unit is moved to a predetermined position.

Preferably, the detection region is formed on a side of the drum, and the limit switch includes a rotation roller contacted with the detection region and an elastic piece for elastically adhering the rotation roller to the side of the drum so as to detect a rotation count of the drum whenever the detection region passes over the rotation roller.

As an alternative, the detection region includes: a disk integrally formed on any one of right and left sides of the drum and rotated in the same direction as the drum; and concave and convex portions alternately formed on a side or an outer circumference of the disk at regular intervals and contacted with the limit switch in turns when the drum is rotating.

In another aspect of the present invention, the lifting apparatus includes one main lifting reel and at least one auxiliary lifting reel, which are electrically connected with each other, wherein each of the main and auxiliary lifting reels includes: a detection region formed on the drum; and a limit switch for detecting the detection region to count a rotation of the drum, wherein the main lifting reel further includes a controller for receiving the rotation count detected by the limit switch and rotating the drum as much as a preset rotation number such that the moving unit is moved to a pre-determined position.

Preferably, the controller includes: a function of driving the main lifting reel and the auxiliary lifting real when an ascend or descend signal is input, and then checking states of the main lifting reel and the auxiliary lifting real; a function of emergently stopping both of the main lifting reel and the auxiliary lifting real when an abnormal signal is detected from any one of the main lifting reel and the auxiliary lifting reel; and a function of, in case there occurs a deviation between the numbers of rotations of the drums of the main lifting reel and the auxiliary lifting reel during a normal operation state, instantly stopping or slowing operating a driving motor of a lifting reel moving faster such that the moving unit keeps a balance.

In addition, the controller may include: a function of adding a rotation count detected by the limit switch and rotating the drum until the added rotation count reaches a preset rotation count set to descend the moving unit to a predetermined position, and then stopping the moving unit; a function of emergently stopping the drum in case the rotation count is not reduced at a constant time interval while the descended moving unit is ascending; a function of stopping the ascending drum in case the moving unit reaches a zero position (or, an initial position) while the moving unit is ascending without error; a function of, in case the rotation count is not reduced to zero but unchanged over a predetermined time within a predetermined range, recognizing the status as a complete ascend and stopping the ascending drum; and a function of resetting the rotation count into zero at a position where the moving unit is completely ascended and thus the driving motor stops operation, wherein the controller substantially implements the above functions so as to descend and then ascend the moving unit.

Preferably, a plurality of sensor holes are installed at regular intervals in an edge of one side of the drum, and a non-contact type sensor is installed adjacent to the sensor holes such that the non-contact type sensor detects the sensor holes when the drum is rotating, and then sends a detection signal to the controller.

At this time, the non-contact type sensor may be an optical sensor or an approach sensor.

Preferably, a hook to which the moving unit is connected is installed to the other end of the wire.

Preferably, the hook is a plate-shaped press material integrally including a hooking portion connected to the moving unit and a fixture coupled with the wire and having a predetermined area.

Also preferably, when being coupled to the wire, the fixture is bent into a circular shape and the compressed with an end of the wire being inserted into the circular fixture.

In another aspect of the present invention, the other end of the wire is fixed to a wire fixing unit installed to the lifting reel, the lifting apparatus further includes a lifting body, which has a plurality of rotation rolls horizontally spaced apart from each other by a predetermined distance, and a hook formed in a lower portion of the lifting body and connected with the moving unit, and the rotation rolls of the lifting body are placed on the wire between the fixed roll and the wire fixing unit such that the lifting body is hung on the wire.

Preferably, at least two horizontal wires are installed in parallel with a pre-determined tensile force on an upper surface of the moving unit, and the wire is connected to a center of each horizontal wire.

As an alternative, an intermediate fixture having a connection ring is installed to a center of the horizontal wire at a position corresponding to the center of gravity of the moving unit, and the hook formed at the lower end of the wire is connected to the connection ring.

Preferably, a pair of guide walls, each having an insert groove in an upper portion thereof, is formed at a predetermined interval between the upper surface of the moving unit and the horizontal wire at a position corresponding to the center of gravity of the moving unit such that the horizontal wire is arranged to be inserted into the insert groove, and the wire is connected to the horizontal wire between the pair of guide walls.

Preferably, both ends of the horizontal wire are fixed to the moving unit by means of horizontal wire fixtures installed on the upper surface of the moving unit, and a spring is installed to at least one of the horizontal wire fixtures such that the horizontal wire is connected to the horizontal wire fixture via the spring.

Preferably, the lifting apparatus is provided with one main lifting reel and at least one auxiliary lifting reel, which are electrically connected with each other, and the main lifting reel includes: a wireless receiving sensor for receiving a wireless signal transmitted from an external wireless manipulator; and a controller for controlling the main lifting reel and the auxiliary lifting reel at the same time according to the signal received in the wireless receiving sensor.

Preferably, the auxiliary lifting reel includes: a power plug connected to an external power source; and a power supplier for supplying the power, supplied to the power plug, again to the main lifting reel.

Preferably, the lifting apparatus may further include a magnet, which is attached to a predetermined position of the moving unit in case the moving unit is inclined, so as to balance the moving unit.

### BRIEF DESCRIPTION OF THE DRAWINGS

FIG. 1 is a perspective view showing a lifting apparatus having a lifting reel according to the present invention.

FIG. 2 is a perspective view showing that a moving unit is closely attached to the lifting apparatus of FIG. 1.

FIG. 3 is a schematic view showing an inner configuration of a lifting reel according to one embodiment of the present invention.

FIG. 4 is a schematic view showing an inner configuration of a lifting reel according to another embodiment of the present invention.

FIG. 5 is a schematic view showing an inner configuration of a lifting reel according to still another embodiment of the present invention.

FIG. 6 is a schematic view showing an inner configuration of a lifting reel according to further another embodiment of the present invention.

FIG. 7 is a schematic view showing that a wire is guided by a plurality of guide rolls provided to the lifting reel of the present invention.

FIG. 8 is a perspective view showing that two lifting reels are electrically connected with each other in a lifting apparatus according to one embodiment of the present invention.

FIG. 9 is a perspective view showing that a moving unit is closely attached to a fixed unit in the lifting apparatus of FIG. 8.

FIG. 10 is a plane view showing the lifting apparatus of FIG. 8.

FIG. 11 is a sectional view showing the lifting apparatus of FIG. 8.

FIG. 12 is a perspective view showing a contact-type rotation control means provided to the lifting apparatus according to one embodiment of the present invention.

FIG. 13 is a schematic view showing the contact-type rotation control means of FIG. 12.

FIG. 14 is a perspective view showing a modification of the contact-type rotation control means of FIG. 12.

FIG. 15 is a perspective view showing a non-contact type rotation control means provided to the lifting apparatus according to another embodiment of the present invention.

FIG. 16 is a schematic view showing the non-contact type rotation control means of FIG. 15.

FIG. 17 is a perspective view showing a modification of the non-contact type rotation control means of FIG. 15.

FIG. 18 is a sectional view showing that a single wire is used in a two-line structure according to one embodiment of the present invention.

FIG. 19 shows a modification of FIG. 18.

FIG. 20 is a perspective view showing that a horizontal wire is installed to a moving unit and connected to a wire according to one embodiment of the present invention.

FIG. 21 is a perspective view showing that a guide wall is installed to the horizontal wire of the moving unit according to one embodiment of the present invention.

FIG. 22 is a perspective view showing the guide wall of FIG. 21 in more detail.

FIG. 23 is a perspective view showing that a magnet is attached to a moving unit according to one embodiment of the present invention.

FIG. 24 is a schematic view showing a conventional hook.

FIG. 25 is a schematic view showing that a hook according to one embodiment of the present invention is coupled to the wire.

FIG. 26 is a perspective view showing the hook of FIG. 25.

FIG. 27 is a perspective view showing that a fixture of the hook of FIG. 26 is bent into a circular shape.

FIG. 28 is a front view showing a modification of FIG. 26.

FIG. 29 is a front view showing a modification of FIG. 26.

### BEST MODE FOR CARRYING OUT THE INVENTION

Hereinafter, preferred embodiments of the present invention will be described in detail with reference to the accompanying drawings.

First, a lifting apparatus having a lifting reel according to the present invention may be applied to all kinds of products including a fixed unit positioned at a certain height and a moving unit movable up and down below the fixed unit, and the present invention will be explained using an air conditioner installed to the ceiling and having a lifting grill as an example. However, the present invention may also be applied to various products such as a highly-mounted lamp, a chandelier and a batten for lights above the stage with the same concept, and they should be interpreted to be include in the scope of the present invention.

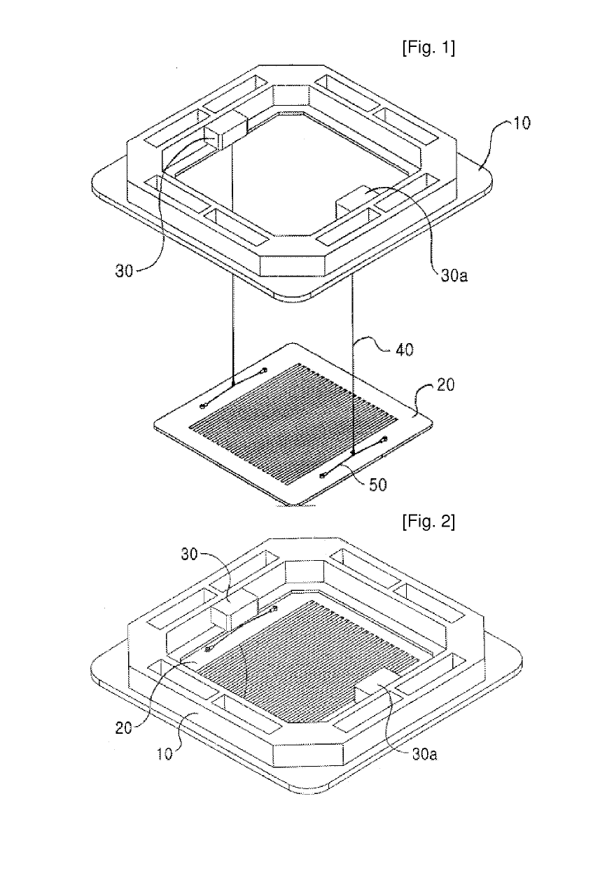

FIG. 1 shows an air conditioner at the ceiling, which includes a lifting reel according to the present invention. The air conditioner includes a fixed unit 10 fixed to the ceiling, a grill 20 positioned below the fixed unit 10, and a lifting reel 30 installed to the fixed unit 10 and connected to the grill 20 by means of a wire 40 to move the grill 20 up and down. Hereinafter, the grill 20 installed below the fixed unit 10 to be movable up and down will be called a moving unit.

The lifting reel 30 moves the moving unit 20 up or down by winding or unwinding the wire 40 around/from an internal drum. If the moving unit 20 ascends by the lifting reel 30, the moving unit 20 is closely attached to the fixed unit 10, as well shown in FIG. 2.

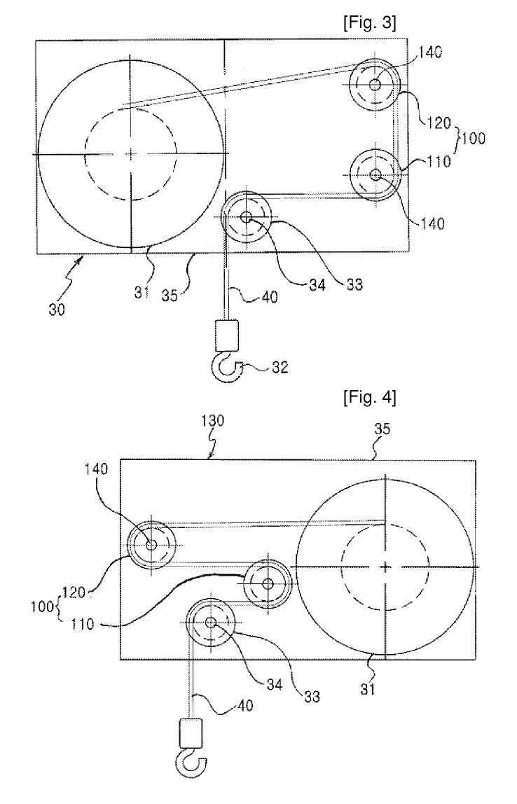

FIG. 3 is a schematic view showing an inner configuration of a lifting reel according to one embodiment of the present invention. Referring to FIG. 3, the lifting reel 30 of this embodiment includes a body 35 installed to the ceiling or the fixed unit 10 fixed to the ceiling, a drum 31 arranged in the body 35 and rotated in a clockwise/counterclockwise direction by a driving motor (not shown), a wire 40 having one end fixed to the drum 31 and the other end connected to the moving unit 20 and wound/unwound around the drum 31, a fixed roll 33 keeping a predetermined space from the drum 31 and rotated on a fixed roll shaft 44 to guide the wire 40 while the wire 40 taken-up around the drum 31 is wound or unwound, and a plurality of guide rolls 100 arranged between the drum 31 and the fixed roll 33.

In the lifting reel 30 of this embodiment, when the wire 40 is wound around the drum 31, the plurality of guide rolls 100 arranged between the drum 31 and the fixed roll 33 make the wire 40 be wound uniformly on the entire outer circumference of the drum 31 with keeping substantially perpendicular to the drum 31.

In the present invention, two or three guide rolls 100 are preferably arranged between the drum 31 and the fixed roll 33. The guide rolls 100 are rotatably coupled to guide roll shafts 140, to be movable axially on the guide roll shafts 140, respectively.

In the prior art, only one guide roll was arranged between the drum and the fixed roll, so a wire was mostly wound around the center of the drum since the guide roll cannot guide the wire to both side ends of the drum. However, in this embodiment, the plurality of guide rolls 100 guide the wire 40 in a wider range, so the wire 40 is more naturally wound around the entire outer circumference of the drum 31 uniformly. Meanwhile, in case more than three guide rolls are arranged, a production cost may be increased due to an increased size or complicated configuration of the lifting reel.

Referring to FIG. 3 again, the guide rolls 100 of this embodiment include a first guide roll 110 and a second guide roll 120. The first guide roll 110 and the second guide roll 120 are arranged vertically with a predetermined interval. In this state, when the wire 40 is taken-up around the drum 31, the wire 40 is wound on the drum 31 with passing over the fixed roll 33, the first guide roll 110 and the second guide roll 120 in order. At this time, the first guide roll 110 moves just a little in an axial direction based on the center of the drum 31, but the second guide roll 120 guides the wire 40 with moving to both side ends of the drum 31 on the guide roll shaft 140. Thus, the wire 40 is uniformly wound on the drum 31 with keeping a substantially perpendicular state to the drum 31.

Meanwhile, the first guide roll 110 and the second guide roll 120 are not limited to the above vertical arrangement, but they may be arranged in different ways if they may guide the wire 40 to both side ends of the drum 31. For example, the first guide roll 110 and the second guide roll 120 may be arranged in a zigzag pattern as shown in FIG. 4.

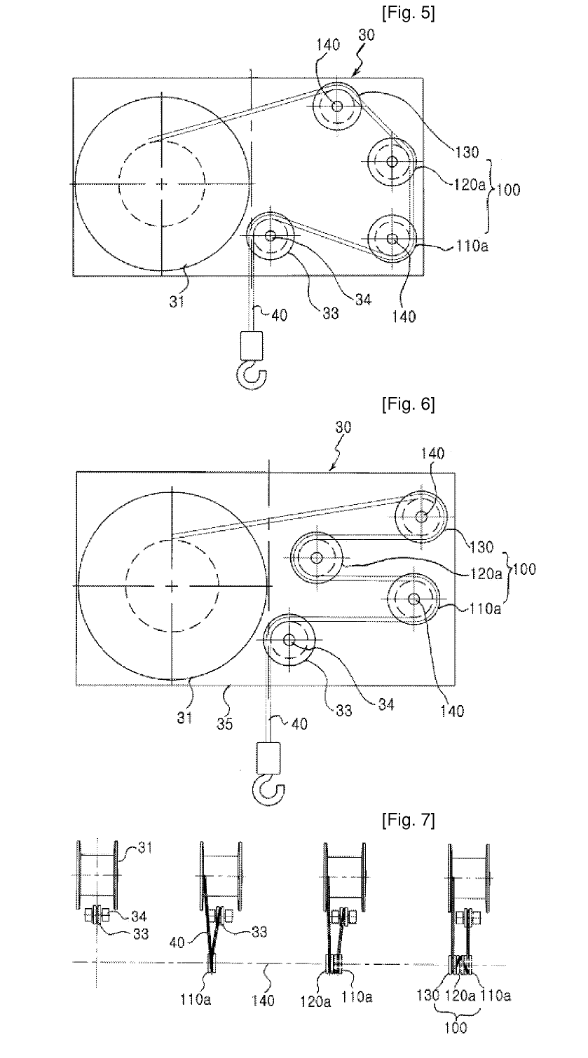

FIG. 5 shows another example that the lifting reel 30 has three guide rolls. In this embodiment, the guide rolls 100 are composed of a first guide roll 110a, a second guide roll 120a and a third guide roll 130, and the first, second and third guide rolls 110a, 120a, 130 are arranged vertically. These first, second and third guide rolls 110a, 120a, 130 are not limited to the vertical arrangement, but the first, second and third guide rolls 110a, 120a, 130 may also be arranged in a zigzag pattern on occasions as shown in FIG. 6, if they may guide the wire 40 to both side ends of the drum 31.

In case three guide rolls 110 are configured as mentioned above, the wire 40 may be more precisely guided to both side ends of the drum 31 using the first, second and third guide rolls 110a, 120a, 130 arranged vertically or in a zigzag pattern between the drum 31 and the fixed roll 33.

That is to say, as shown in FIG. 7, the wire 40 is wound around the drum 31 with passing over the first, second and third guide rolls 110a, 120a, 130, arranged between the drum 31 and the fixed roll 33, in order. At this time, the first guide roll 110a guides the wire 40 with moving a little in an axial direction based on the center of the drum 31, the second guide roll 120a guides the wire 40 more outwardly than the first guide roll, and the third guide roll 130 guides the wire 40 to both side ends of the drum 31, so the wire 40 is wound on the drum 31 to both side ends of the drum 31 with being kept substantially perpendicular to the drum 31.

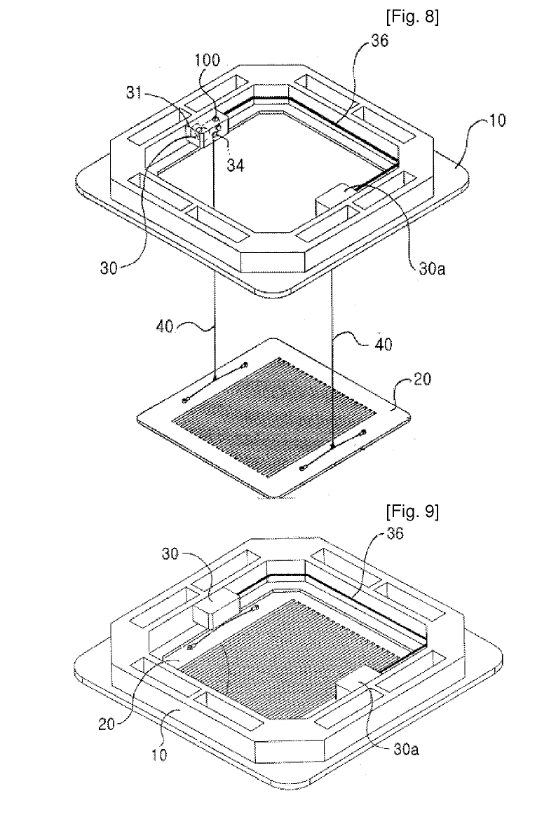

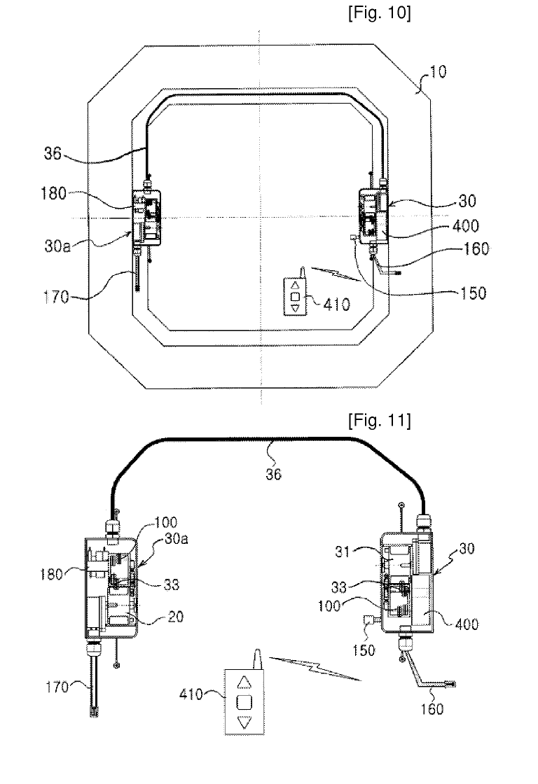

The lifting apparatus of the present invention may be provided with at least two lifting reels 30. At this time, at least two lifting reels 30 may be independently operated, but preferably operated together in electric connection with each other. FIGS. 8 to 11 show that lifting reels 30 are electrically connected as mentioned above

Referring to FIGS. 8 to 11, this embodiment is illustrated such that two lifting reels 30, 30a are installed to the lifting apparatus. That is to say, two lifting reels 30, 30a are respectively installed to positions spaced apart from each other, and both lifting reels 30, 30a are electrically connected with each other using an electric line 36. Each of the lifting reels 30, 30a includes a drum 31 around which a wire 40 is taken up, and an end of the wire 40 is connected to an upper portion of the moving unit 20. At this time, the wires 40 of the lifting reels 30, 30a are connected to the upper portion of the moving unit 20 at corresponding positions, spaced apart by a predetermined interval.

Though this embodiment is illustrated such that the lifting reels 30, 30a are electrically connected using the electric line 36, the present invention is not limited thereto, but the lifting reels 30, 30a may also be connected using a signal line.

One lifting reel 30 of the lifting reels 30, 30a (hereinafter, referred to as a main lifting reel) includes a wireless receiving sensor 150 and a controller 400. The wireless receiving sensor 150 receives a wireless signal transmitted from an external wireless manipulator 410, and the controller 400 controls the lifting reels 30, 30a according to the signal received in the wireless receiving sensor 150. At this time, the wireless signal used by the wireless receiving sensor 150 and the wireless manipulator 410 is preferably an infrared signal.

In addition, the other lifting reel 30a of the lifting reels 30, 30a (hereinafter, referred to as an auxiliary lifting reel) includes a power plug 170 connected to an external power source, and a power supplier 180 for supplying the external power to the main lifting reel 30 again.

Meanwhile, in this embodiment, the main lifting reel 30 may be modified in various ways if the main lifting reel 30 and the auxiliary lifting reel 30a may be operated together, not limited to the case that the main lifting reel 30 and the auxiliary lifting reel 30a are operated using the wireless manipulator 410 and the wireless receiving sensor 150. For example, it is also possible that a separate manual control signal connector 160 is installed to a lower end of the main lifting reel 30, the manual control signal connector 1650 is electrically connected to the manipulator 410 of the lifting apparatus, and then the main lifting reel 30 and the auxiliary lifting reel 30a are operated manually.

The lifting apparatus configured as above is operated as follows. First, the main lifting reel 30 includes a driving motor, a drum 31, a wire 40, a guide roll 100, a fixed roll 33, a wireless receiving sensor 150 and a controller 400, and the auxiliary lifting reel 30a includes a driving motor, a drum 31, a wire 40, a guide roll 100, a fixed roll 33, a power plug 170 and a power supplier 180.

After that, the wire 40 of the main lifting reel 30 is connected to a right center of the top of the moving unit 20, and the wire of the auxiliary lifting reel 30a is connected to a left center of the top of the moving unit 20.

Then, the fixed unit 10 is installed to the ceiling of a building or at a predetermined height such that the main lifting reel 30 and the auxiliary lifting reel 30a are positioned respectively to right and left inner walls of the fixed unit 10, and the moving unit 20 is closely attached to the lower end of the fixed unit 10.

In this state, if the power plug 170 is electrically connected to an external power, the power is supplied to the auxiliary lifting reel 30a, and the main lifting reel 30 receives the power through the power supplier 180 and the power line 36.

In this state, in order to descend the moving unit 20 for the purpose of cleaning or exchange, a user presses a descend button of the wireless manipulator 410 to send a descend signal to the wireless receiving sensor 160. If the descend signal received in the wireless receiving sensor 160 is input to the controller 400 (see FIG. 13), the controller 400 operates the main lifting reel 30 and the auxiliary lifting reel 30a at the same time.

In more detail, if the controller 400 outputs a descend signal, power is applied to the driving motors of the main lifting reel 30 and the auxiliary lifting reel 30a accordingly, so the wires 40 are unwound by the rotating drums 31 such that the moving unit 20 moves down.

Meanwhile, in order to ascend the moving unit 20 again after the work, the user presses an ascend button of the wireless manipulator 410 to send an ascend signal to the wireless receiving sensor 160, and the controller 400 receives the signal and controls the main lifting reel 30 and the auxiliary lifting reel 30a at the same time to move the moving unit 20 upward.

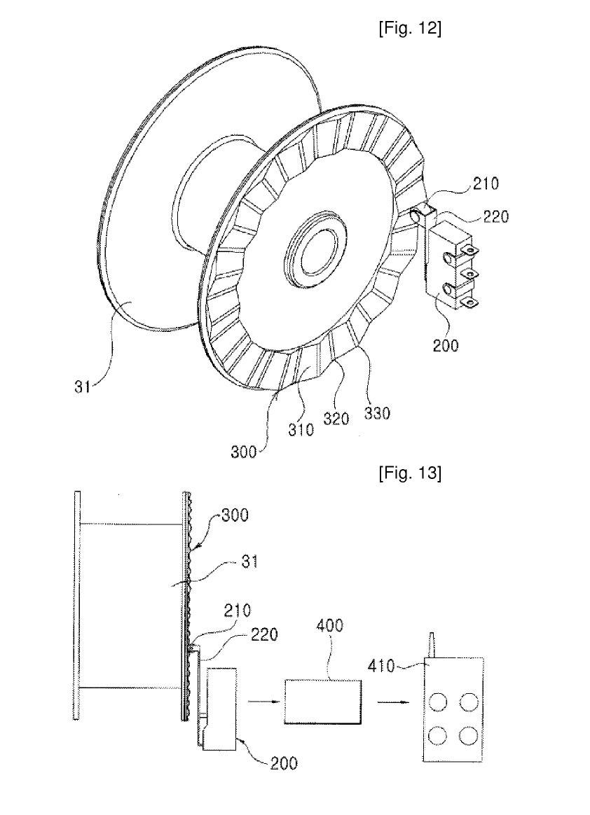

The lifting apparatus of the present invention may further include a rotation control means for detecting a rotation of the drum 31 and controlling the number of rotations. The rotation control means of this embodiment is well shown in FIG. 12.

Referring to FIG. 12, the rotation control means includes a detection region 300 formed on a side of the drum 31 in the lifting reel 30; a limit switch 200 having a rotation roller 210 formed at a top thereof to pass over the detection region 300 while the drum 31 is rotating, and an elastic piece 220 formed at a lower end of the rotation roller 210 to elastically adhere the rotation roller 210 to the side of the drum 31 such that the limit switch 200 detects a rotation of the drum whenever the detection region 30 passes over the rotation roller 210; and a controller 400 for receiving the number of rotations detected by the limit switch 200 and rotating the drum 31 as much as a preset rotation number so that the moving unit 20 is moved to a predetermined position.

In addition, the other lifting reel 30a installed to the fixed unit 10 at a position spaced apart from the lifting reel 30 is also provided with a rotation control means identical or similar to the above rotation control means. That is, the lifting reel 30a basically includes a detection region 300 and a limit switch 200, and the number of rotations of the drum detected by the limit switch 200 of the lifting reel 30a is sent to the controller 400 (see FIG. 13). In this embodiment, the lifting reel 30 including the controller 400 is called a main lifting reel, and the lifting reel 30a not including the controller 400 is called an auxiliary lifting reel. Though the lifting apparatus of this embodiment is illustrated to have one auxiliary lifting reel, it is also possible to install a plurality of auxiliary lifting reels.

The detection region 300 is formed on any one of right and left sides of the drum 31. The detection region 300 includes a disk 310 rotating in the same direction as the drum 31, and concave and convex portions 320, 330 alternately formed at regular intervals on a side or an outer circumference of the disk 310. The concave and convex portions 320, 330 substantially contact with the limit switch 200 while the drum 31 is rotating, and the limit switch 200 accurately detects the number of rotations of the drum accordingly.

The detection region 300 of this embodiment is formed on the side of the drum 31 as shown in FIG. 12, but not limitedly. That is, it is also possible that concave and convex portions 320, 330 are formed on the outer circumference of the disk 310 to form the detection region 300, as shown in FIG. 14, if the limit switch 200 may detect the number of rotations of the drum. As another alternative, it is also possible that a detection region and a limit switch are formed on a driving shaft positioned between the drum and a reduction gear to detect the number of rotations of the drum. The detection regions mentioned above are all corresponding to an output part that provides a rotational force. Thus, the present invention should be understood to include all modifications that detect the number of rotations of the drum using a rotation count of the output part.

The lifting reel of this embodiment is operated as follows. While the main lifting reel 30 and the auxiliary lifting reel 30a are wire-connected to allow signal transmission, if an ascend or descend signal is input to the main lifting reel 30 to which the controller 400 is installed, the main lifting reel 30 continuously checks a current status of the auxiliary lifting reel 30a using the controller 400. At this time, if an abnormal signal is detected from any one of both lifting reels during ascending/descending, the controller 400 emergently stops both of the main and auxiliary lifting reels 30, 30a. In addition, if both of the main and auxiliary lifting reels 30, 30a operate normally but there occurs a deviation between count values of the main lifting reel 30 and the auxiliary lifting reel 30a, the controller 400 instantly turns on and off or slowly operates the driving motor of a lifting reel moving faster such that the moving unit 20 keeps its balance.

The main lifting reel 30 controlled by the manipulator 410 as mentioned above takes a main charge by including not only the limit switch 200 and the detection region 300 for keeping a horizontal balance of the moving unit during ascending/descending but also the controller 400 that receives the number of rotations detected by the limit switch 200 and controls the rotation, and the auxiliary lifting reel 30a includes only the limit switch 200 and the detection 300, so it is controlled by the above controller 400.

If the drum 31 rotates using a driving force transferred from the driving motor, the limit switch 200 plays a role of detecting the number of rotations of the drum and then sending the detected number of rotations to the controller 400. This limit switch 200 is not limited to a specific one, but the limit switch 200 may employ a non-contact type sensor such as an approach sensor as well as a contact-type limit switch as mentioned above in order to detect the number of rotations of the drum.

If a descend signal is input to the main and auxiliary lifting reels 30, 30a through the manipulator 410, the limit switches 200 respectively detect the number of rotations of the drums that are rotated using a driving force from the driving motors. In this process, if the numbers of rotations detected by the limit switches 200 respectively installed to the main and auxiliary lifting reels 30, 30a do not reach a predetermined value within a preset time of the controller 400, the controller 400 emergently stops both of the main and auxiliary lifting reels 30, 30a. In addition, if there occurs a difference between the numbers of rotations of the main and auxiliary lifting reels 30, 30a so that the moving unit 20 does not keep its horizontal balance, the controller 400 may selectively control the driving motors of the main and auxiliary lifting reels 30, 30a so as to horizontally balance the moving unit 20.

For example, the controller 400 installed to the main lifting reel 30 is configured to check the numbers of rotations of the drums of the main and auxiliary lifting reels 30, 30a. The controller 400 includes a program, which repeatedly instantly stops and operates or slowly operates the driving motor of a lifting reel whose number of rotations is detected greater, in case there occurs a deviation between the main and auxiliary lifting reels 30, 30a, and which then allows normal ascending/descending of the moving unit 20 if the numbers of rotations of the main and auxiliary lifting reel 30, 30a are detected identical; and a program, which emergently stops both lifting reels including even a normally operating lifting reel, in case any of the main and auxiliary lifting reels is malfunctioned or the moving unit 20 is caught by an obstacle or contacted with the ground such that no load is applied to the wire 40.

Thus, the controller 400 includes a function of adding a rotation count detected by the limit switch 200, rotating the drum 31 until the added rotation count reaches a preset value set in the manipulator 410 to descend the moving unit 20 to a pre-determined position, and then stopping the moving unit 20; a function of emergently stopping the drum 31 if the rotation count is not reduced at a constant time interval while the descended moving unit 20 is ascended; a function of stopping the ascending drum 31 if the moving unit 20 reaches a zero position (or, an initial position) while the rotation count is reduced without error; a function of, if the rotation count is not reduced to zero but unchanged over a predetermined time within a predetermined range of 1 or 2, recognizing it as a complete ascend and stopping the drum 31; and a function of resetting the rotation count into zero at a position where the moving unit 20 is completely ascended and thus the driving motor stops its operation. The controller 400 substantially implements the above functions so as to descend and then ascend the moving unit.

Meanwhile, the controller, the manipulator and the limit switch are related using common electric circuits, so such circuitry relations are not explained in detail here. In addition, the signal transmission between the main lifting reel 30 and the auxiliary lifting reel 30a may be realized using a cable, but the present invention is not limited thereto. That is to say, it is also possible to provide bi-directional wireless communication modules to the main and auxiliary lifting reels 30, 30a respectively so that the main and auxiliary lifting reels 30, 30a transmit signals wirelessly, if the lifting reels may be controlled.

In the lifting reel of this embodiment, configured as above, the number of rotations of the drum varies depending on a thickness of the wire 40, an amount of wire taken-up around the drum 31, or a point of the wire at which the wire taken-up around the drum 31 is unwound.

Thus, if the fixed unit 10 having the detection region 300 and the limit switch 200 is installed to the ceiling, a worker firstly descends the moving unit 20 to a position suitable for working. If the moving unit 20 reaches a suitable position, the worker sets the number of rotations of the drum at that position to the controller 400.

If a descend button of the manipulator 410 is pressed with the above setting for the purpose of cleaning the moving unit 20, the driving motor rotates the drum 31, and, as the drum 31 rotates, the wire 40 taken-up around the drum 31 is unwound so that the moving unit 20 descends.

At this time, while the drum 31 is rotating, the rotation roller 210 closely contacted with the side or the edge of the disk 310 passes over the concave and convex portions 320, 330 in order, and the limit switch 200 detects every instance of the rotating drum, and the detected number of rotations is input to the controller 400.

If the drum keeps rotating in the above state and then reaches the number of rotations set in the controller 400, the power of the driving motor is automatically intercepted to stop the descending operation of the moving unit 20.

In more detail, in a state that the main and auxiliary lifting reels 30, 30a are respectively installed to right and left inner walls of the moving unit 10 and also the wires 40 of the main and auxiliary lifting reels 30, 30a are respectively connected to right and left sides of the upper surface of the moving unit 20, if the manipulator 410 is manipulated to input a descend signal to the main and auxiliary lifting reels 30, 30a, the main and auxiliary lifting reels 30, 30a start operating at the same time.

If the driving motors of the main and auxiliary lifting reels 30, 30a rotate the drum 31, the limit switch 200 detects the number of rotations of the drum 31, and the detected number of rotations is transferred to the controller 400. At the same time, the wire 40 is unwound from the drum 31 to descend the moving unit 20.

While the drum keeps rotating, if the numbers of rotations of the drums 30, 31a of the main and auxiliary lifting reels 30, 30a are identical to the number of rotations set in the controller 400, the controller 400 determines that the main and auxiliary lifting reels 30, 30a are operating normally, and then keeps the descending operation.

However, if the numbers of rotations of the drums of any lifting reel do not reach a desired value within a preset time set in the controller 400 during the descending operation, or if the moving unit 20 is caught by an obstacle or collided with the ground and thus any one of both wires 40 comes to a no-load state, the controller 400 sends stop signals to the main and auxiliary lifting reels 30, 30a to emergently stop both main and auxiliary lifting reels 30, 30a. After that, the lifting reels are operated again after solving the problem.

Meanwhile, if the numbers of rotations of the main and auxiliary lifting reels 30, 30a are not detected identically but have a deviation, the controller 400, which continuously manages the numbers of rotations of drums of the lifting reels 30, 30a, slowly rotates the driving motor of a lifting reel with a greater rotation detected. That is to say, a lifting reel with a greater rotation detected is operated slowly, and the other lifting reel is operated normally, thereby decreasing the deviation between them. After that, if the numbers of rotations of drums of the main and auxiliary lifting reels 30, 30a become identical, the controller 400 allows normal ascending/descending operation of the moving unit successively.

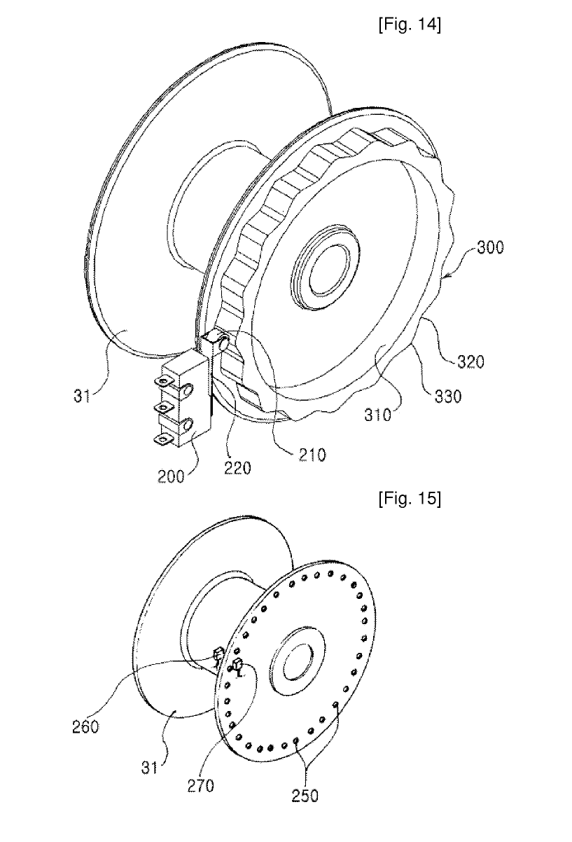

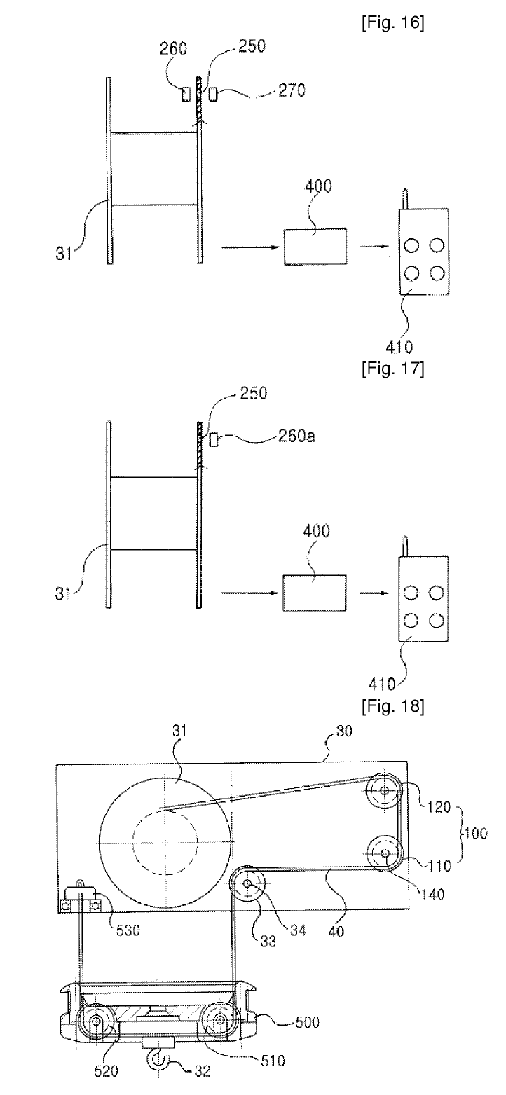

FIGS. 15 and 16 show another example of a rotation control device provided to the lifting apparatus according to the present invention. In this embodiment, the rotation control means employs a non-contact type sensor.

Referring to FIGS. 15 and 16, a plurality of sensor holes 250 are formed in an edge of one side of the drum 31 at regular intervals. In addition, a first optical sensor 260 and a second optical sensor 270 are installed to both sides of the sensor holes 250 to be spaced apart from each other. The first and second optical sensors 260, 270 detect the sensor holes 250 whenever the sensor holes 250 pass between the optical sensors 260, 270, and then sends the number of rotations of the drum to the controller 400.

The sensor holes 250 are selectively formed in only one side among the right and left sides of the drum 31. Though the sensor holes 250 are illustrated to be formed in the right side, the sensor holes 250 may also be formed in the left side on occasions if they allows to detect the number of rotations of the drum 31. If the sensor holes 250 are formed in the left side of the drum 31, the first and second optical sensors 260, 270 are also installed to the left side of the drum 31.

Meanwhile, though it has been illustrated that the first and second optical sensors 260, 270 are used for detecting the number of rotations of the drum 31, the present invention is not limited thereto, but various configurations capable of detecting the number of rotations of the drum 31 in a non-contact type may also be applied thereto. For example, it is also possible that an approach sensor 260a is installed to an outer side of the drum 31 as shown in FIG. 17 such that the approach sensor 260a detects the sensor holes 250 whenever the sensor holes 250 pass near the approach sensor 260a, for calculating the entire number of rotations of the drum 31.

In this embodiment configured as above, the number of rotations of the drum 31 varies depending on a thickness of the wire 40, an amount of wire 40 taken-up around the drum 31, or a point at which the wire 40 taken-up around the drum 31 is unwound.

Thus, if the lifting apparatus having the sensor holes 250 and the first and second optical sensors 260, 270 are installed at a predetermined height, a worker firstly descends the moving unit 20 to a position suitable for working, and the number of rotations of the drum 31 at this time is displayed on the manipulator 410. At this time, the number of rotations is set to the controller 400.

In the state that the setting is completed as above, the user presses a descend button of the manipulator 410 for the purpose of exchanging or cleaning the moving unit, and then the driving motor rotates the drum 31 such that the wire 40 taken-up around the drum 31 is unwound, and accordingly the moving unit 20 moves down.

At this time, if the drum 31 rotates, the sensor holes 250 formed in its edge rotate between the first optical sensor 260 and the second optical sensor 270, and the first and second optical sensors 260, 270 detect the sensor holes 250 passing between them.

Thus, since the first and second optical sensors 260, 270 detect the sensor holes 250 whenever the sensor holes 250 pass between the optical sensors 260, 270, the first and second optical sensors 260, 270 resultantly detect the rotation of the drum 31 continuously. Meanwhile, the detected number of rotations is input to the controller 400, and the number of rotations input to the controller 400 is displayed on a screen of the manipulator 410.

If the number of rotations of the drum 31 becomes identical to the number of rotations set to the controller 400 while the drum 31 keeps rotating, the power supplied to the driving motor is automatically intercepted to stop the descending movement of the moving unit 20.

Meanwhile, the lifting reel 30 provided to the lifting apparatus of the present invention is configured such that one end of the wire 40 is fixed to the drum 31 and the hook 32 is installed to the other end of the wire 40, as shown in FIG. 3, so the moving unit 20 is coupled to the hook 32. That is to say, in the embodiment of FIG. 3, the lifting reel 30 of the present invention is configured to be coupled with the moving unit 20 using only a single line structure. However, the present invention is not limited thereto, but the lifting reel 30 may be connected to the moving unit 20 with a two line structure by just using only one wire, by means of a lifting body, as shown in FIG. 18.

In more detail, the lifting reel 30 of this embodiment includes a wire fixing unit 530 installed to a lower end of the body of the lifting reel 30 so as to fix the end of the wire 40, and a lifting body 500 supported and hung by the wire 40 with the wire 40 being fixed to the wire fixing unit 530.

The lifting body 500 includes a pair of rotation rolls 510, 520, horizontally spaced apart from each other by a predetermined distance, and the wire 40 is placed below the rotation rolls 510, 520. That is to say, the lifting body 500 is hung to the wire 40 by placing the rotation rolls 510, 520 on the wire 40. A hook 32 is installed to a lower portion of the lifting body 500, preferably a lower center of the lifting body 500, for connection with the moving unit 20.

At this time, the end of the wire 40 may be fixed to the wire fixing unit 530 or not fixed. That is, while the end of the wire 40 is fixed to the wire fixing unit 530, the lifting body 500 is coupled to the wire 40 as shown in FIG. 18 such that the wire 40 is used in a two-line structure. However, in the state that the end of the wire 40 is not fixed to the wire fixing unit 530, the wire 40 is used in a single-line structure as shown in FIG. 3.

For example, if a single-line structure is required, the wire 40 is extended below the lifting reel 30 via the second guide roll 110, the first guide roll 120 and the fixed roll 33, with one end of the wire 40 being fixed to the drum 31 in the lifting reel 30, and the hook 32 is installed to the other end of the wire 40. In addition, the moving unit 20 is suspended to the hook 32 installed to the other end of the wire 40.

If a descend signal is input to the lifting reel 30 with the wire 40 being assembled in a single-line structure, the driving motor gives a driving force to rotate the drum 31, and accordingly the wire 40 taken-up around the drum 31 is unwound and accordingly descends the moving unit 20 via the second guide roll 120, the first guide roll 110 and the fixed roll 33.

On the contrary, if an ascend signal is input, the wire 40 is wound around the drum 31 with passing over the fixed roll 33, the first guide roll 110 and the second guide roll 120 in order. At this time, the fixed roll 33 is rotated based on the fixed roll shaft 34 as the wire is wound or unwound, and the first and second guide rolls 110, 120 move in an axial direction along the guide roll shafts 140 and guide the wire 40 such that the wire 40 may be uniformly wound on the entire outer circumference of the drum 31.

Meanwhile, if a two-line structure is required, the wire 40 is extended below the lifting reel 30 via the second guide roll 120, the first guide roll 110 and the fixed roll 33 with one end of the wire 40 being fixed to the drum 31 in the lifting reel 30, and the other end of the wire 40 is fixed to the wire fixing unit 530 installed to the lifting reel 30. In addition, the rotation rolls 510, 520 of the lifting body 500 is placed on the wire 40 in the region between the fixed roll 33 and the wire fixing unit 530 such that the lifting body 500 is suspended on the wire 40 between the fixed roll 33 and the wire fixing unit 530. In addition, the moving unit 20 is connected to the hook 32 installed to the lower center of the lifting body 500.

If a descend signal is input to the lifting reel 30 while the wire is assembled into the two-line structure, the driving motor gives a driving force to rotate the drum 31.

At this time, the wire 40 taken-up around the drum 31 is unwound below with passing over the second guide roll 120, the first guide roll 110 and the fixed roll 33 in order. In addition, since the end of the wire 40 is fixed to the wire fixing unit 530 via the rotation rolls 510, 520, the lifting body 500 is moved down with keeping its horizontal state by the rotation rolls 510, 520 such that the moving unit 20 installed to the hook 32 is descended.

On the contrary, if an ascend signal is input, the wire 40 is wound around the drum 31 with passing over the rotation rolls 510, 520, the fixed roll 33, the first guide roll 110 and the second guide roll 120 in order.

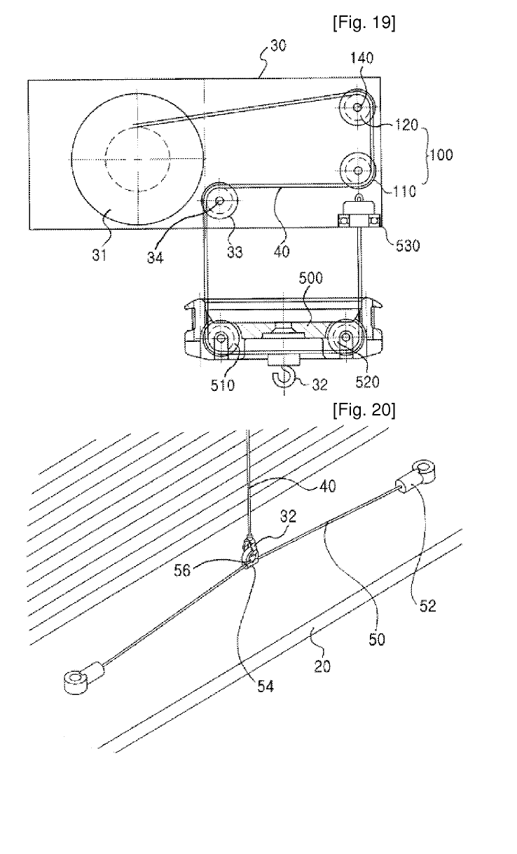

Meanwhile, the lifting reel 30 having a two-line wire structure is not limited to the embodiment of FIG. 18 in which the end of the wire 40 is fixed to a lift side, but the wire fixing unit 530 may also be formed in right lower end of the lifting reel 30 as shown in FIG. 19 such that the end of the wire is fixed to the wire fixing unit 530 installed in a right side.

Referring to FIG. 1 again, the lifting apparatus according to the present invention may be configured such that a horizontal wire 50 is separately installed to the moving unit 20 such that the wire 40 is connected to the horizontal wire 50. The horizontal wire 50 is well shown in FIG. 20.

As shown in FIG. 20, a pair of horizontal wire fixtures 52 are installed to an upper portion of the moving unit 20, and both ends of the horizontal wire 50 are respectively fixed to the horizontal wire fixtures 52. At this time, the horizontal wire 50 is tightly fixed with a predetermined tensile force to the horizontal wire fixtures 52. An intermediate fixture 54 is installed to a center of the horizontal wire 50, and a connection ring 56 is provided to the intermediate fixture 54. The connection ring 56 is installed on a central line of the moving unit 20, that is corresponding to the center of gravity, and the hook 32 formed at the end of the wire 40 is connected to the connection ring 56. In case the hook 32 is formed at a lower portion of the lifting body 500 as shown in FIGS. 18, 19, the connection ring 56 is connected to the hook 32 formed at the lower portion of the lifting body 500.

In addition, though not shown in the figures, in this embodiment, a spring may be fixed to the horizontal wire fixture 52 such that the horizontal wire 50 is connected to the spring. In this case, since the spring continuously pulls the horizontal wire 50, the spring prevents the horizontal wire 50 from becoming loose. The spring is preferably a coil spring with a high modulus of elasticity, and the spring may be installed to both or any of two horizontal wires 50.

In this embodiment, the horizontal wires 50 are respectively installed to both sides of the upper surface of the moving unit 20. That is to say, in this embodiment, two horizontal wires 50 are installed in parallel, and each horizontal wire is connected to the lifting reel using a separate wire. In this configuration, two wires 40 prevents the moving unit from being inclined in a right and left direction, and the horizontal wires 50 prevent the moving unit 20 from being inclined in a front and rear direction, so the moving unit 20 may be kept horizontally in all directions. In addition, since the horizontal wire 50 has a tensile force in itself, the horizontal wire 50 may relieve an impact between the moving unit 20 and the fixed unit 10 when the wire 40 is completely wound around the drum 31. Also, after the wire 40 is completely wound around the drum 31, the horizontal wire 50 continuously pulls the moving unit 20 upward by means of the tensile force in itself, thereby preventing the moving unit 20 from drooping down and thus not causing any gap between the fixed unit 10 and the moving unit 20.

In order to make the lifting apparatus of this embodiment, a horizontal wire 50 is firstly prepared with a predetermined length, and then the intermediate fixture 54 is coupled to the center of the horizontal wire 50.

After that, both ends of the horizontal wire 50 are respectively fixed to the upper surface of the moving unit 20 by means of the horizontal wire fixtures 52, and the hook 32 formed at the end of the wire 40 is connected to the connection ring 56 provided to the intermediate fixture 54 such that the wire 40 is connected to the horizontal wire 50.

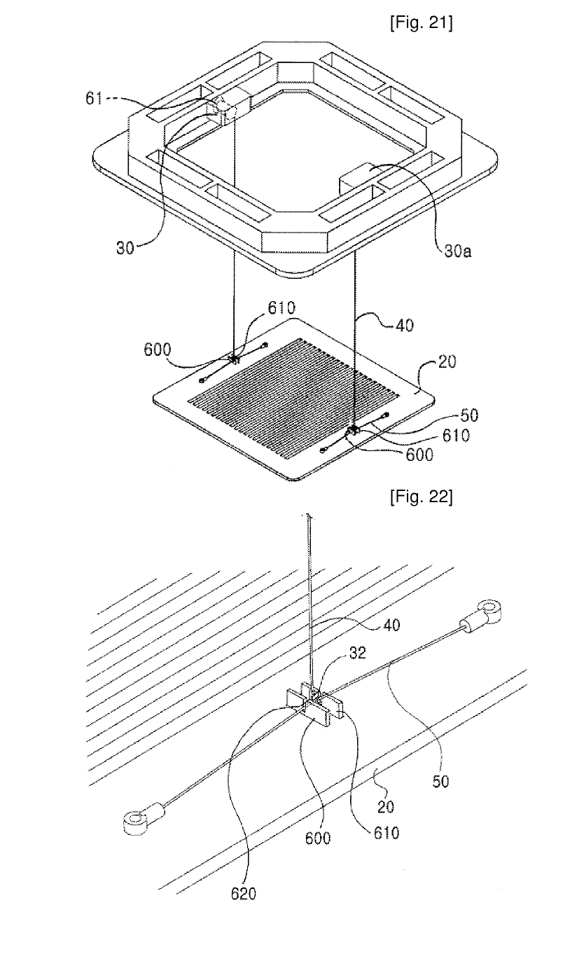

Meanwhile, though this embodiment has been illustrated such that the intermediate fixture 54 having the connection ring 56 is installed to the horizontal wire 50, there may be many variations. For example, in order to connect the hook 32 to the horizontal wire 50 in a stable way, separate guide walls 600, 610 may be formed on the moving unit 20 as shown in FIGS. 21 and 22, instead of installing the intermediate fixture to the horizontal wire 50.

Referring to FIGS. 21 and 22, two horizontal wires 50 are formed on both sides of the upper portion of the moving unit 20 to have a predetermined tensile force, respectively, and the guide walls 600, 610 are arranged with a predetermined interval to a center of each horizontal wire 50, namely at a position corresponding to the center of gravity of the moving unit 20. At this time, the guide walls 600, 610 are arranged between the horizontal wire 50 and the upper surface of the moving unit 20 with a pre-determined height, and an insert groove 620 is formed in the upper portion of the guide walls 600, 610 such that the horizontal wire 50 is inserted into the insert groove 620. In addition, the hook 32 installed at the end of the wire 40 is connected to the horizontal wire 50 between the guide walls 600, 610.

The guide walls 600, 610 may be injection-molded integrally when the moving unit 20 is made. In addition, when the hook 32 is connected with the horizontal wire 50 with the horizontal wire 50 being inserted into the insert groove 620, the guide walls 600, 610 preferably have a suitable height such that the hook 32 and the horizontal wire 50 do not deviate out of the guide walls 600, 610. If the guide walls 600, 610 have a low height, the hook 32 and the horizontal wire 50 may deviate from the guide walls 600, 610.

In this embodiment configured as above, the horizontal wire 50 and the hook 32 are connected with each other as follows. First, the guide walls 600, 610 having the insert groove 620 formed in its upper portion are integrally made when the moving unit 20 is made, and then both ends of the horizontal wire 50 are fixed to the upper end of the moving unit 20 with the center of the horizontal wire 50 being inserted into the insert groove 620. Then, the horizontal wire 50 is installed to the horizontal wire fixtures at the upper portion of the moving unit 20 via the insert groove 620 of the guide walls 600, 610.

In this state, if the hook 32 installed at the end of the wire 40 is connected to the horizontal wire 50 between the guide walls 600, 610, the hook 32 may be conventionally connected to the center of the horizontal wire 50 without any special centering work. After the hook 32 is connected to the horizontal wire 50 as mentioned above, the moving unit 20 may ascends or descends by the lifting reel 30.

The hook 32 mentioned above is always positioned between the guide walls 600, 610, so the moving unit 20 may continuously keep its horizontal balance while moving up and down though an external interference is exerted to the moving unit 20.

In addition, in this embodiment, a spring for continuously pulling the horizontal wire 50 to be kept tightly may also be installed to the horizontal wire fixtures 52. The spring is preferably a coil spring with a high modulus of elasticity, and the spring may be installed to both or any of two horizontal wires 50.

At this time, even when the end of the wire 40 is fixed to the lifting reel 30 and the hook 32 is installed to the lower portion of the lifting body 500 as shown in FIGS. 18 and 19, the hook 32 may be connected to the horizontal wire 50 between the guide walls 600, 610.

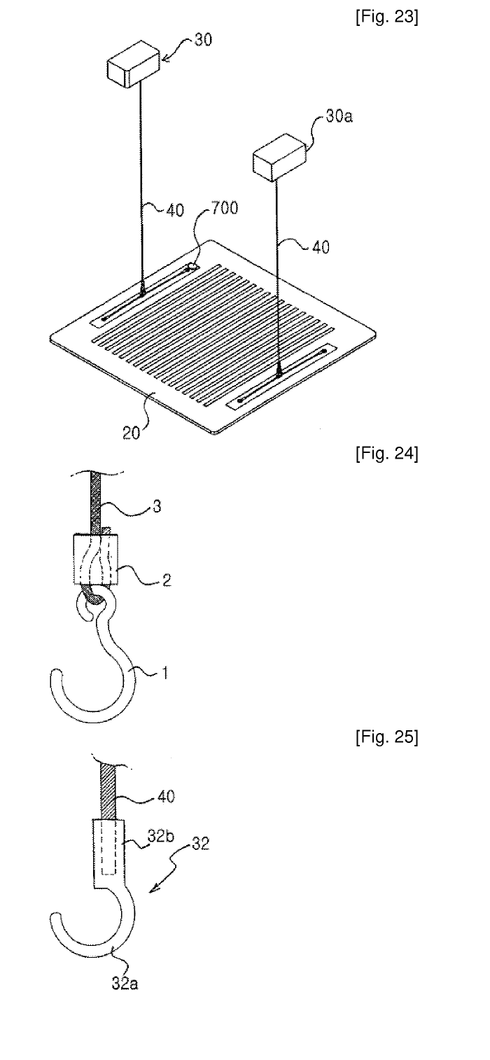

Meanwhile, the lifting apparatus of the present invention may easily balance the moving unit 20 using a magnet in case the moving unit 20 is at least partially made of metal. FIG. 23 shows an example of balancing the moving unit 20 using a magnet 700.

This magnet may be applied to all of the above embodiments. For example, if the moving unit 20 is inclined to one side, the magnet 700 is attached to a suitable position of the moving unit 20 such that the moving unit 20 keeps its balance. At this time, the magnet 700 may have various sizes and weights.

Meanwhile, the lifting apparatus of the present invention includes the hook 32 at the lower end of the wire 40 for the purpose of connection with the moving unit 20. A conventional hook 1 is connected to a wire 3 using a separate fixture 2 as shown in FIG. 24, but in this embodiment, the hook 32 is formed to have a hooking portion 32a and a fixture 32b integrally, and this integral hook 32 is coupled to the wire 40.

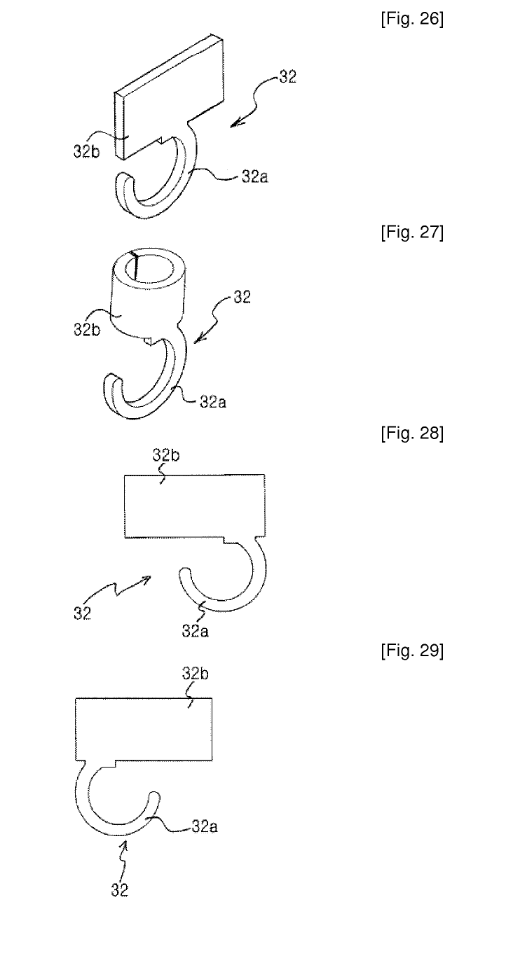

That is to say, referring to FIGS. 25 and 26, the hook 32 of this embodiment includes the hooking portion 32a in its lower portion, and the fixture 32b is integrally formed on the hooking portion 32a. This hook 32 is shaped into a flat shape, preferably by means of compression molding.

The fixture 32b is bent into a circular shape as shown in FIG. 27, when being coupled to the wire 40, and the end of the wire 40 is inserted into the circular fixture 32b. After that, the fixture 32b is compressed such that the hook 32 is integrally fixed to the end of the wire 40.

Meanwhile, the hook 32 of this embodiment is illustrated such that the hooking portion 32a is formed at a lower center of the fixture 32b. However, the hooking portion 32b may also be formed in a lower right side of the fixture 32b as shown in FIG. 28 or in a lower left side of the fixture 32b as shown in FIG. 29. Even in the above cases, the fixture 32b may be bent into a circular shape and compressed to the wire 40.

In order to make such a hook 32, firstly, a steel plate with a predetermined thickness is prepared, and then the hook 32 having the fixture 32b and the hooking portion 32a integrally is made by means of compression molding. Here, the compression molding is widely used in the art, so it is not described in detail here.

Meanwhile, the hook 32 of this embodiment may decrease a loss of the wire 40 during its installation process since the end of the wire 40 is coupled with the fixture 32b.

The hook 32 coupled to the wire 40 in this way may be connected to the moving unit 20.

### INDUSTRIAL APPLICABILITY

As explained above, the lifting apparatus having the lifting reel according to the present invention winds a wire connected to a moving unit around a drum via a plurality of guide rolls arranged in the lifting reel, so the wire is guided to both side ends of the drum by means of the guide rolls and thus uniformly wound around the outer circumference of the drum.

In addition, the lifting apparatus according to the present invention may be designed in a smaller size since the wire may be uniformly taken up around the drum by means of the plurality of guide rolls without increasing an outer diameter of the drum or increasing a distance between the drum and the guide rolls. Also, the lifting reel according to the present invention may easily take up a large amount of wire around the drum, so the lifting reel may be installed to the ceiling at a great height.

In addition, the lifting apparatus of the present invention may move up and down the moving unit in a safe and convenient way since a plurality of lifting reels are electrically connected with other and driven together.

In addition, the lifting apparatus of the present invention accurately detect the number of rotations of the drum using the limit switch and then moves the moving unit to a desired position accurately, with ensuring the moving unit to keep its balance without any inclination during the ascending and descending process.

In addition, the lifting apparatus of the present invention has a plurality of sensor holes in an edge of a side of the drum and detects passage of the sensor holes by optical sensors, thereby capable of precisely detecting the number of rotations of the drum in a non-contact way. Accordingly, the lifting apparatus of the present invention may descend the moving unit to a desired position accurately.

In addition, the lifting apparatus of the present invention may use the wire coupled to the lifting reel in a single-line or two-line structure selectively. Also, in case the wire is used in a two-line structure, the moving unit suspended to the wire may move more stably.

In addition, the lifting apparatus of the present invention may move the moving unit more stably by installing a pair of horizontal wires on the moving unit and connecting the wire of the lifting reel to the center of each horizontal wire. Furthermore, the horizontal wire lessens an impact by its tensile force when the fixed unit and the moving unit meet, and also the horizontal wire continuously pulls the moving unit upward while the wire is completely wound around the drum, thereby preventing the moving unit from drooping.

In addition, the lifting apparatus of the present invention may easily connect the wire to the center of gravity of the moving unit without any special balancing work by providing a pair of guide walls to the horizontal wire installed to the moving unit and then connecting the wire between the guide walls. Also, since the connection between the wire and the horizontal wire is fixed by means of the guide walls, the moving unit may keep its valance continuously while ascending or descending though an external impact is applied thereto.

In addition, the lifting apparatus of the present invention includes a separate magnet such that, in case the moving unit is inclined down in one side, the magnet is attached to a suitable position in its opposite side, thereby easily balancing the moving unit.

In addition, the lifting apparatus of the present invention includes a hook integrally having a hooking portion connected to the moving unit and a fixture coupled to the wire, which is made by compression molding, thereby reducing the number of necessary parts and allowing easier coupling work.

1. A lifting apparatus including a fixed unit positioned at a predetermined height and a moving unit installed below the fixed unit to be movable up and down, the lifting apparatus including at least one lifting reel to move the moving unit up and down, the lifting reel including:
a body installed to the fixed unit;
a drum arranged in the body and rotated by a driving motor in a clockwise/counterclockwise direction;
a wire connected to the moving unit with one end being fixed to the drum so as to be wound or unwound around the drum;
a fixed roll spaced apart from the drum by a predetermined distance and rotated on a fixed roll shaft to guide the wire while the wire taken-up around the drum is wound or unwound; and
at least two guide rolls arranged between the drum and the fixed roll to guide the wire,
wherein the at least two guide rolls guide the wire substantially perpendicular to the drum while the wire is wound around the drum.

2. The lifting apparatus according to claim 1,
wherein two or three guide rolls are arranged between the drum and the fixed roll, and the guide rolls are rotatably coupled to guide roll shafts respectively and movable in an axial direction on the guide roll shafts.

3. The lifting apparatus according to claim 2,
wherein the guide rolls are composed of a first guide roll and a second guide roll, and the first and second guide rolls are vertically arranged by a predetermined interval.

4. The lifting apparatus according to claim 2,
wherein the guide rolls are composed of a first guide roll and a second guide roll, and the first and second guide rolls are arranged in a zigzag pattern.

5. The lifting apparatus according to claim 2,
wherein the guide rolls are composed of a first guide roll, a second guide roll and a third guide roll, and the first, second and third guide rolls are vertically arranged.

6. The lifting apparatus according to claim 2,
wherein the guide rolls are composed of a first guide roll, a second guide roll and a third guide roll, and the first, second and third guide rolls are arranged in a zigzag pattern.

7. The lifting apparatus according to claim 1, wherein the lifting reel further includes:
a detection region formed on the drum;
a limit switch for detecting the detection region to count a rotation of the drum; and
a controller for receiving the rotation count detected by the limit switch, and rotating the drum as much as a preset number of rotations such that the moving unit is moved to a predetermined position.

8. The lifting apparatus according to claim 7,
wherein the detection region is formed on a side of the drum, and
wherein the limit switch includes a rotation roller contacted with the detection region and an elastic piece for elastically adhering the rotation roller to the side of the drum so as to detect a rotation count of the drum whenever the detection region passes over the rotation roller.

9. The lifting apparatus according to claim 7, wherein the detection region includes:
a disk integrally formed on any one of right and left sides of the drum and rotated in the same direction as the drum; and
concave and convex portions alternately formed on a side or an outer circumference of the disk at regular intervals and contacted with the limit switch in turns when the drum is rotating.

10. The lifting apparatus according to claim 1,
wherein the lifting apparatus includes one main lifting reel and at least one auxiliary lifting reel, which are electrically connected with each other,
wherein each of the main and auxiliary lifting reels includes:
a detection region formed on the drum; and
a limit switch for detecting the detection region to count a rotation of the drum,
wherein the main lifting reel further includes a controller for receiving the rotation count detected by the limit switch and rotating the drum as much as a preset rotation number such that the moving unit is moved to a predetermined position.

11. The lifting apparatus according to claim 10, wherein the controller includes:
a function of driving the main lifting reel and the auxiliary lifting real when an ascend or descend signal is input, and then checking states of the main lifting reel and the auxiliary lifting real;
a function of emergently stopping both of the main lifting reel and the auxiliary lifting real when an abnormal signal is detected from any one of the main lifting reel and the auxiliary lifting reel; and
a function of, in case there occurs a deviation between the numbers of rotations of the drums of the main lifting reel and the auxiliary lifting reel during a normal operation state, instantly stopping or slowing operating a driving motor of a lifting reel moving faster such that the moving unit keeps a balance.

12. The lifting apparatus according to claim 10, wherein the controller includes:
a function of adding a rotation count detected by the limit switch and rotating the drum until the added rotation count reaches a preset rotation count set to descend the moving unit to a predetermined position, and then stopping the moving unit;
a function of emergently stopping the drum in case the rotation count is not reduced at a constant time interval while the descended moving unit is ascending;
a function of stopping the ascending drum in case the moving unit reaches a zero position (or, an initial position) while the moving unit is ascending without error;
a function of, in case the rotation count is not reduced to zero but unchanged over a predetermined time within a predetermined range, recognizing the status as a complete ascend and stopping the ascending drum; and
a function of resetting the rotation count into zero at a position where the moving unit is completely ascended and thus the driving motor stops operation,
wherein the controller substantially implements the above functions so as to descend and then ascend the moving unit.

13. The lifting apparatus according to claim 1,
wherein a plurality of sensor holes are installed at regular intervals in an edge of one side of the drum, and
wherein a non-contact type sensor is installed adjacent to the sensor holes such that the non-contact type sensor detects the sensor holes when the drum is rotating, and then sends a detection signal to the controller.

14. The lifting apparatus according to claim 13,
wherein the non-contact type sensor is an optical sensor or an approach sensor.

15. The lifting apparatus according to claim 1,
wherein a hook to which the moving unit is connected is installed to the other end of the wire.

16. The lifting apparatus according to claim 15,
wherein the hook is a plate-shaped press material integrally including a hooking portion connected to the moving unit and a fixture coupled with the wire and having a predetermined area.

17. The lifting apparatus according to claim 16,
wherein, when being coupled to the wire, the fixture is bent into a circular shape and the compressed with an end of the wire being inserted into the circular fixture.

18. The lifting apparatus according to claim 1,
wherein the other end of the wire is fixed to a wire fixing unit installed to the lifting reel,
wherein the lifting apparatus further includes a lifting body, which has a plurality of rotation rolls horizontally spaced apart from each other by a predetermined distance, and a hook formed in a lower portion of the lifting body and connected with the moving unit, and
wherein the rotation rolls of the lifting body are placed on the wire between the fixed roll and the wire fixing unit such that the lifting body is hung on the wire.

19. The lifting apparatus according to claim 1,
wherein at least two horizontal wires are installed in parallel with a predetermined tensile force on an upper surface of the moving unit, and
wherein the wire is connected to a center of each horizontal wire.

20. The lifting apparatus according to claim 19,
wherein an intermediate fixture having a connection ring is installed to a center of the horizontal wire at a position corresponding to the center of gravity of the moving unit, and
wherein the hook formed at the lower end of the wire is connected to the connection ring.

21. The lifting apparatus according to claim 19,
wherein a pair of guide walls, each having an insert groove in an upper portion thereof, is formed at a predetermined interval between the upper surface of the moving unit and the horizontal wire at a position corresponding to the center of gravity of the moving unit such that the horizontal wire is arranged to be inserted into the insert groove, and
wherein the wire is connected to the horizontal wire between the pair of guide walls.

22. The lifting apparatus according to claim 19,
wherein both ends of the horizontal wire are fixed to the moving unit by means of horizontal wire fixtures installed on the upper surface of the moving unit, and
wherein a spring is installed to at least one of the horizontal wire fixtures such that the horizontal wire is connected to the horizontal wire fixture via the spring.

23. The lifting apparatus according to claim 6,
wherein the lifting apparatus is provided with one main lifting reel and at least one auxiliary lifting reel, which are electrically connected with each other,
wherein the main lifting reel includes:
a wireless receiving sensor for receiving a wireless signal transmitted from an external wireless manipulator; and
a controller for controlling the main lifting reel and the auxiliary lifting reel at the same time according to the signal received in the wireless receiving sensor.

24. The lifting apparatus according to claim 23, wherein the auxiliary lifting reel includes:
a power plug connected to an external power source; and
a power supplier for supplying the power, supplied to the power plug, again to the main lifting reel.

25. The lifting apparatus according to claim 1, further comprising a magnet, which is attached to a predetermined position of the moving unit in case the moving unit is inclined, so as to balance the moving unit.
